(19) United States
(12) Patent Application Publication
(10) Pub. No.: US 2017/0279568 A1
(43) Pub. Date: Sep. 28, 2017

(54) MULTI-USER FORMATS FOR RTS FRAMES

(71) Applicants: Po-Kai Huang, West Lafayette, IN (US); Yaron Alpert, Hod Hasharoni (IL); Laurent Cariou, Portland, OR (US); Robert J. Stacey, Portland, OR (US); Daniel F. Bravo, Hillsboro, OR (US); Qinghua Li, San Ramon, CA (US)

(72) Inventors: Po-Kai Huang, West Lafayette, IN (US); Yaron Alpert, Hod Hasharoni (IL); Laurent Cariou, Portland, OR (US); Robert J. Stacey, Portland, OR (US); Daniel F. Bravo, Hillsboro, OR (US); Qinghua Li, San Ramon, CA (US)

(21) Appl. No.: 15/200,470

(22) Filed: Jul. 1, 2016

Related U.S. Application Data
(60) Provisional application No. 62/313,519, filed on Mar. 25, 2016.

(51) Int. Cl. H04L 5/00; H04W 72/04

(52) U.S. Cl. CPC H04L 5/005; H04W 72/042; H04W 72/0413

(57) ABSTRACT

Methods and devices are described in which the MU-RTS (multi-user request-to-send) trigger frame is compressed by having a single field trigger a group of users instead of an individual user. This technique also enables the indication of a set of transmission format parameters to the same group of users. In one embodiment, one Per-User Info field of the MU-RTS frame is used to indicate that the CTS (clear-to-send) response is to be transmitted by multiple stations instead of a having a Per-User Info field for each station.

### PRIORITY CLAIM

This application claims priority to U.S. Provisional Patent Application Ser. No. 62/313,519 filed Mar. 25, 2016, which is incorporated herein by reference in their entirety

### TECHNICAL FIELD

Embodiments described herein relate generally to wireless networks and communications systems.

### BACKGROUND

Wireless networks as defined by the IEEE 802.11 specifications (sometimes referred to as Wi-Fi) are currently being advanced to provide much greater average throughput per user to serve future communications needs. 802.11ax, also called High-Efficiency Wireless or HEW, focuses on implementing mechanisms to serve more users a consistent and reliable stream of data in the presence of many other users. One feature of the 802.11ax standard is the use of multi-user (MU) technologies.

### BRIEF DESCRIPTION OF THE DRAWINGS

FIG. 1 illustrates a basic service set that includes station devices associated with an access point.

FIG. 2 shows an example where the AP transmits an MU-RTS to stations STA1 and STA2 before transmitting downlink data according to some embodiments.

FIG. 3 illustrates an example procedure where an AP transmits a Trigger to STA1 and STA2 in order to elicit uplink transmissions according to some embodiments.

FIG. 4 shows the format of an MU-RTS frame according to some embodiments.

FIG. 5 shows an example of a common information field according to some embodiments.

FIG. 6 shows an example of a per user information field according to some embodiments.

FIG. 7 shows an example where a Group 1 consists of 20 MHz only devices and a group 2 consists of 80 MHz capable devices according to some embodiments.

FIG. 8 shows an example where there are four groups of 20 MHz devices camped in different 20 MHz channels according to some embodiments.

FIG. 9 shows an example of the Group ID being located in the User Identifier field or part of the User Identifier field according to some embodiments.

FIG. 10 shows an example of a frame format for the per-user information field according to some embodiments.

FIG. 11 shows an example of a frame format for the per-user information field according to some embodiments.

FIG. 12 shows an example of a frame format for the per-user information field according to some embodiments.

FIG. 13 shows an example of a frame format for the per-user information field according to some embodiments.

FIG. 14 shows an example of a frame format for the per-user information field according to some embodiments,

FIG. 15 shows an example of a frame format for the per-user information field according to some embodiments.

FIG. 16 shows an example of an MU-CTS frame without a high-efficiency long training field (HE-LTF) and high-efficiency short training field (HE-STF) portion according to some embodiments,

FIG. 17 shows an example of an MU-CTS frame with a high-efficiency long training field (HE-LTF) and high-efficiency short training field (HE-STF) portion according to some embodiments.

FIG. 18 shows an example of additional signaling for configuring the MU-CTS physical frame according to some embodiments.

FIG. 19 shows an example of a compressed common information field according to some embodiments.

FIG. 20 illustrates an example of a user equipment device according to some embodiments.

FIG. 21 illustrates an example of a computing machine according to some embodiments.

### DETAILED DESCRIPTION

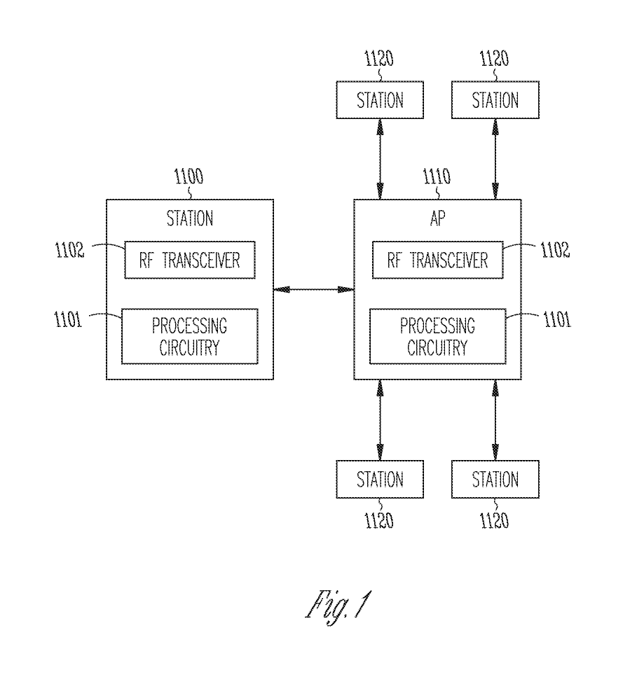

In an 802.11 local area network (LAN), the entities that wirelessly communicate are referred to as stations (STAs). A basic service set (BSS) refers to a plurality of stations that remain within a certain coverage area and form some sort of association and is identified by the SSID of the BSS. In one form of association, the stations communicate directly with one another in an ad-hoc network. More typically, however, the stations associate with a central station dedicated to managing the BSS and referred to as an access point (AP). FIG. 1 illustrates a BSS that includes a station device 1100 associated with an access point (AP) 1110, where the AP 1110 may be associated with a number of other stations 1120. The device 1100 may be any type of device with functionality for connecting to a WiFi network such as a computer, smart phone, or a UE (user equipment) with WLAN access capability, the latter referring to terminals in a LTE (Long Term Evolution) network. Each of the station devices include an RF (radio frequency transceiver) 1102 and processing circuitry 1101 as shown by the depictions of devices 1100 and 1110. The processing circuitry includes the functionalities for WiFi network access via the RF transceiver as well as functionalities for processing as described herein. The RF transceivers of the station device 1100 and access point 1110 may each incorporate one or more antennas. The RF transceiver 1100 with multiple antennas and processing circuitry 101 may implement one or more MIMO (multi-input multi-output) techniques such as spatial multiplexing, transmit/receive diversity, and beam forming. The devices 1100 and 1110 are representative of the wireless access points and stations described below.

In an 802.11 WLAN network, the stations communicate via a layered protocol that includes a physical layer (PHY) and a medium access control (MAC) layer. The MAC layer is a set of rules that determine how to access the medium in order to send and receive data, and the details of transmission and reception are left to the PHY layer. At the MAC layer, transmissions in an 802.11 network are in the form of MAC frames of which there are three main types: data frames, control frames, and management frames. Data frames carry data from station to station. Control frames, such as request-to-send (RTS) and clear-to-send (CTS) frames are used in conjunction with data frames deliver data reliably from station to station. Management frames are used to perform network management functions. Management frames include beacon frames which are transmitted periodically by the AP at defined beacon intervals and which contain information about the network and also indicate whether the AP has buffered data which is addressed to a particular station or stations. Other management frames include probe request frames sent by a station probing for the existence of a nearby AP and probe response frames sent by an AP in response to a probe request frame.

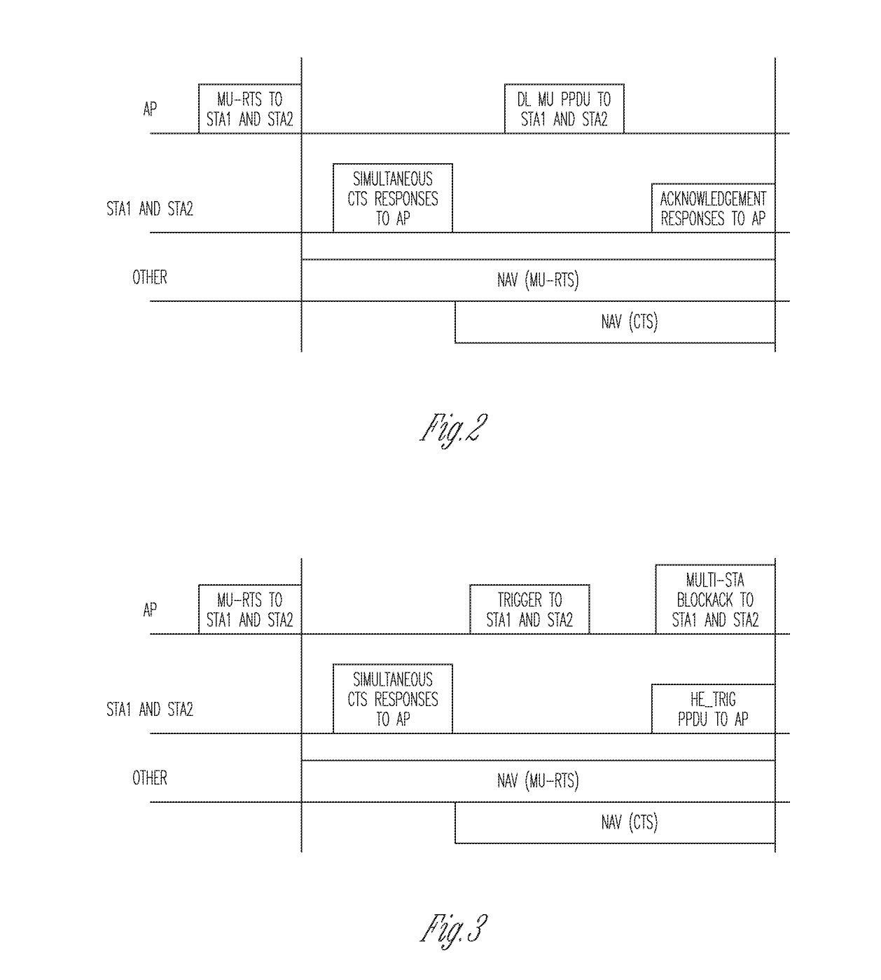

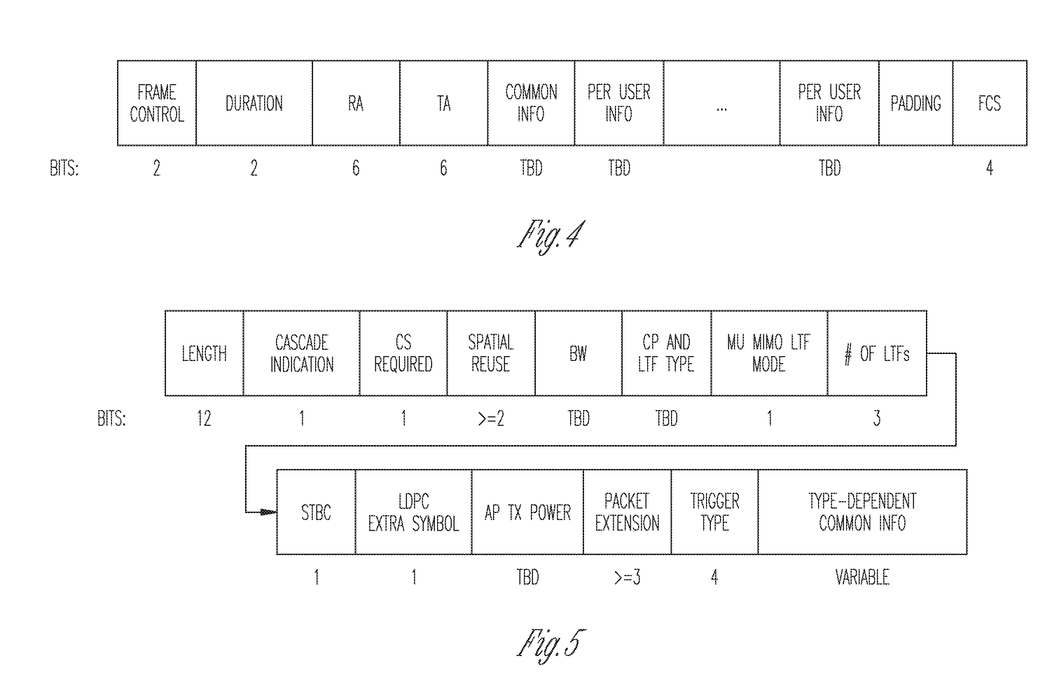

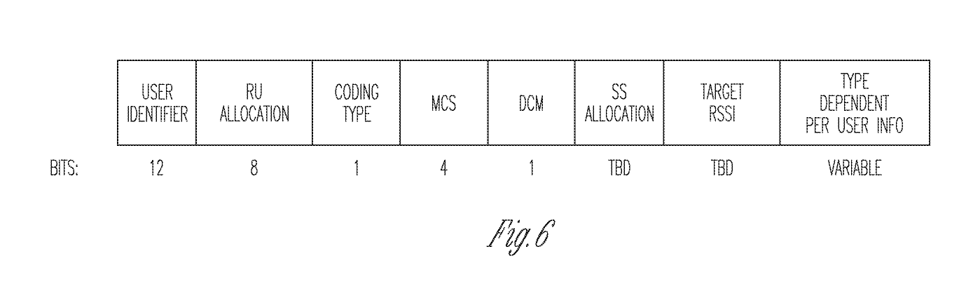

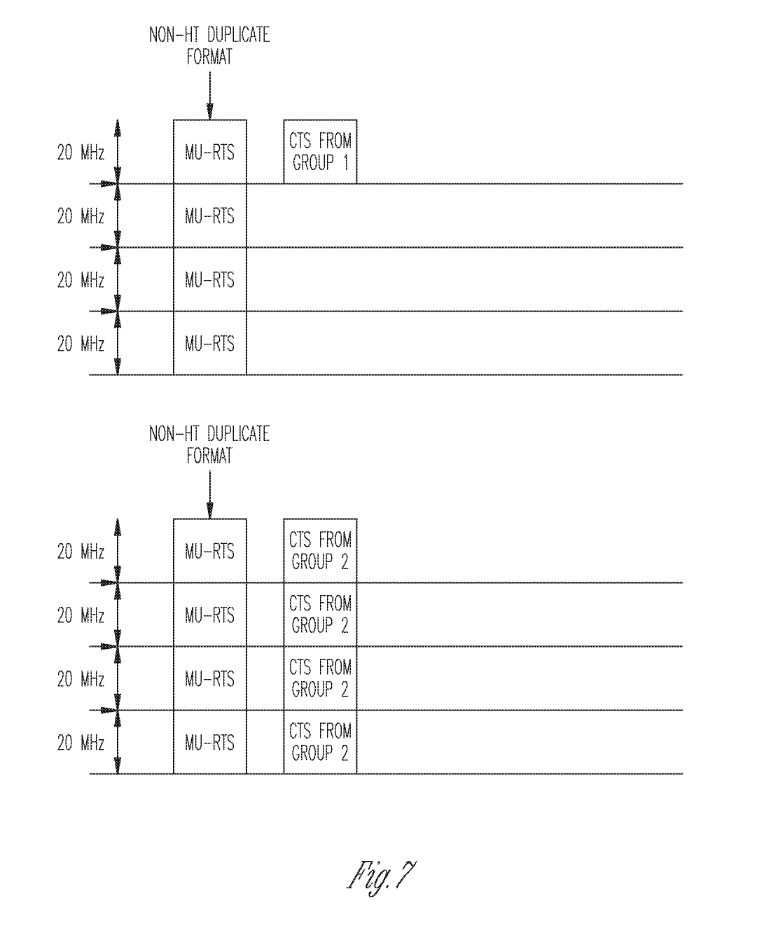

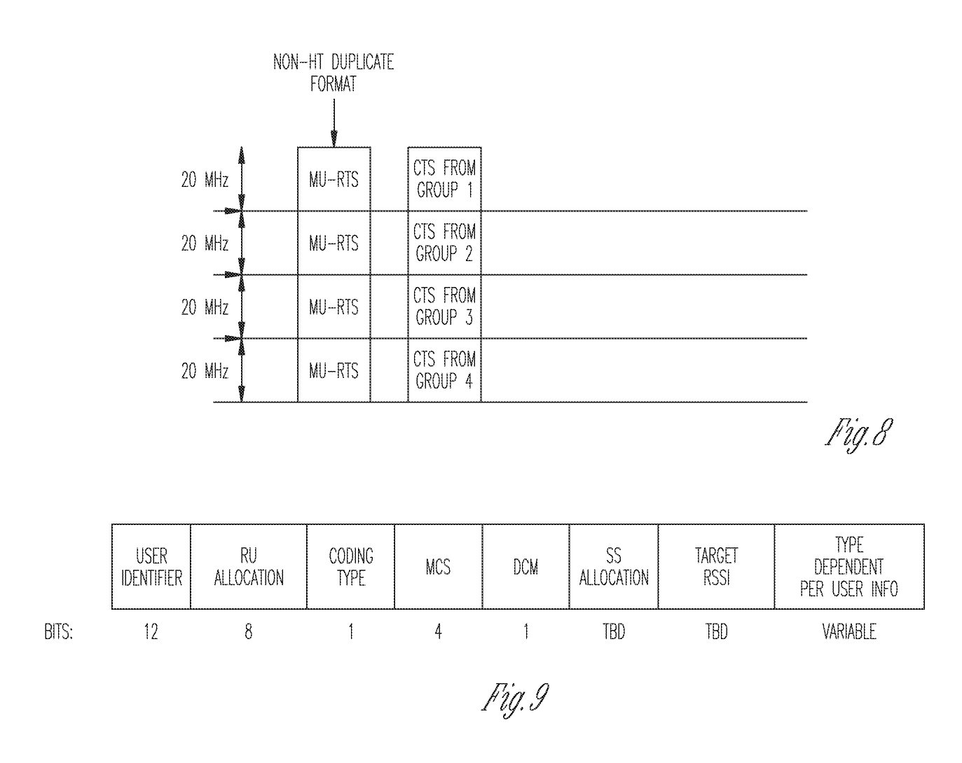

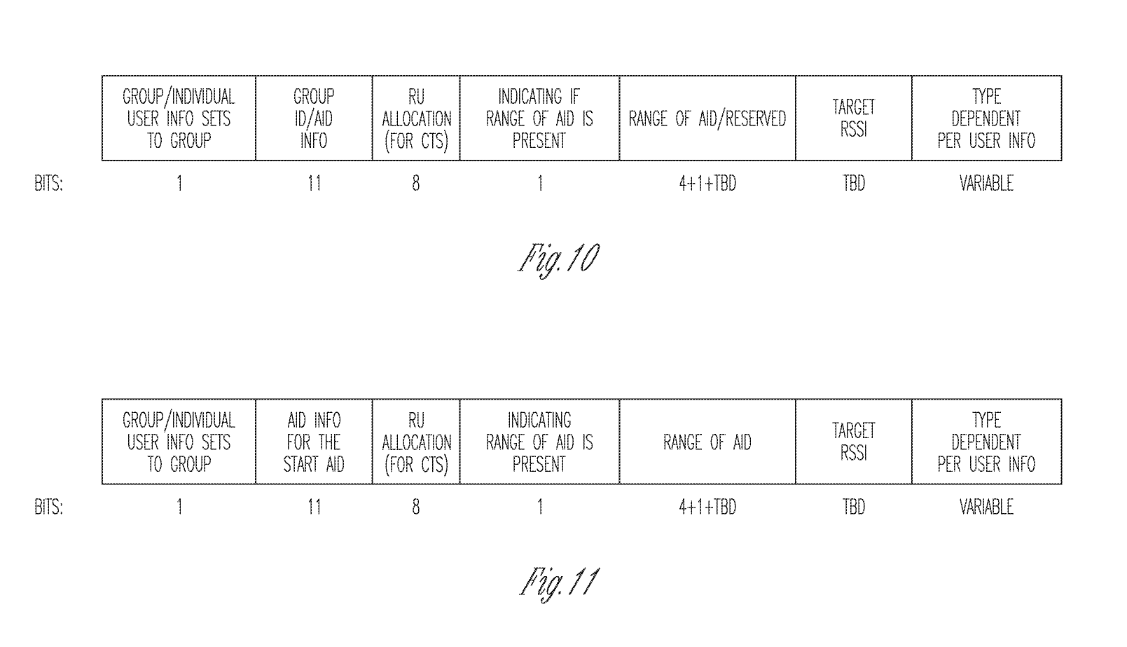

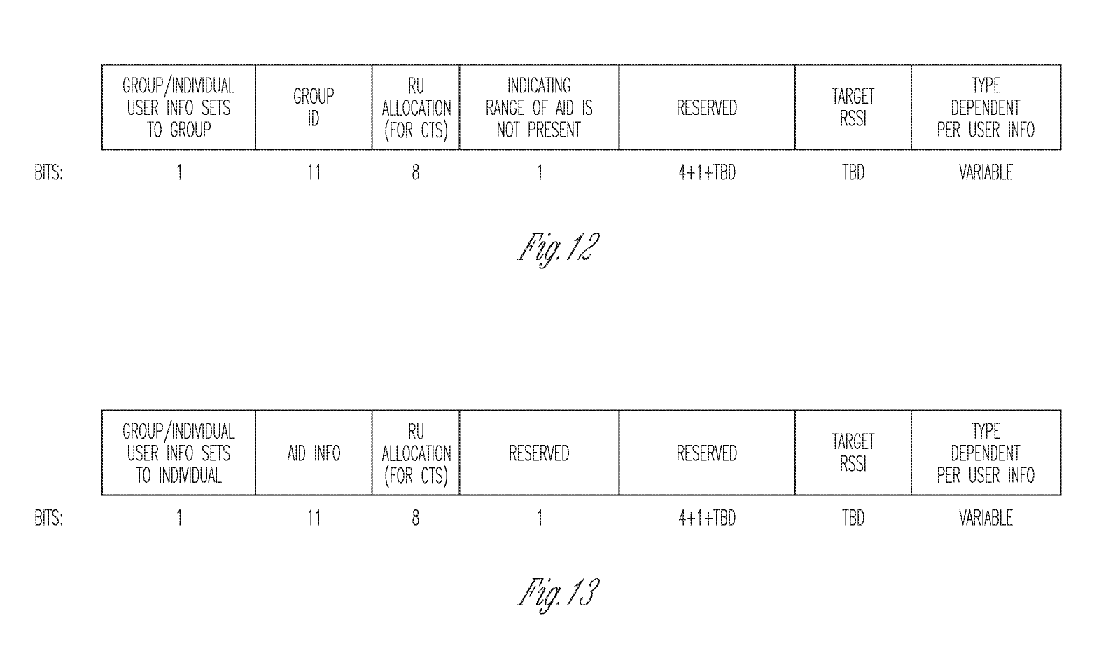

The current IEEE 802.11ax specification describes a multi-user (MU) protection procedure based on transmission of MU-RTS (which is a trigger frame subtype) by the AP to initiate simultaneous CTS responses from multiple STAs. The MU-RTS/CTS procedure allows a high-efficiency (HE) AP to protect its MU transmission for HE STAs. FIGS. 2 and 3 illustrate examples of this procedure. FIG. 2 shows an example where the AP transmits an MU-RTS to stations STA1 and STA2 before transmitting downlink (DL) data. The duration field of the MU-RTS carries a NAV (network allocation vector) setting that lasts from the end of the MU-RTS until the end of the Acknowledgement Responses from STA1 and STA2. Simultaneous CTS responses are transmitted from STA1 and STA2 with NAV settings that last until the end of the Acknowledgement Responses from STA1 and STA2 in response to the DL MU physical protocol data unit (PPDU) transmission from the AP to STA1 and STA2. FIG. 3 illustrates a similar procedure where the AP transmits a Trigger to STA1 and STA2 after receiving the CTS responses transmitted from STA1 and STA2 in order to elicit uplink transmissions from those stations (labeled as HE-Trig PPDU to AP) to which the AP responds with a block acknowledgement (labeled as Multi-Sta Block Ack to STA1 and STA2).

FIG. 4 shows the format of an MU-RTS frame according to some embodiments, which is a variant of a trigger frame. The frame includes a common information field (Common Info) and one or more per user information fields (Per User Info). FIG. 5 illustrates the Common Info field, and FIG. 6 illustrates the Per User Info field. In each of the figures the number of bits are given for each sub-field or it is designated as to be determined (TBD) according to the current specifications.

As described above, an MU-RTS may trigger multiple STAs to respond with a CTS simultaneously where the number of users may be the number of users participating in the following MU DL or UL operation (e.g., can be up to 72 users according to the current specifications). The length of the MU-RTS may thus be very long, which will increase the overhead and decrease the available duration of a transmission opportunity (TXOP). This is exacerbated by the fact that a Trigger frame (such as an MU-RTS) needs to be transmitted at the lower rate of the basic rate set. For example, assume that each per-user information field is about 5 bytes. If we have 32 STAs triggered for MU-CTS response, then the length of the per-user information field is at least 160 bytes, the duration of which is at least 210 us with a 6 Mbps modulation and coding scheme (MCS) which is the lowest rate of the basic rate set. If we add the lengths of the preamble for non-HT (non-high throughput) format (20 us), the MAC header (20 bytes around 26 us), and the common info field (e.g., 5 bytes taking 7 us), the length of MU-RTS becomes 263 us. Note that an RTS frame with non-HT format is only around 46 us.

Described herein are methods and devices in which the MU-RTS trigger frame is compressed by having a single field trigger a group of users instead of an individual user. This technique also enables the indication of a set of transmission format parameters to the same group of users. In one embodiment, one Per-User Info field of the MU-RTS frame is used to indicate that CTS response is to be transmitted by multiple STAs instead of a having a Per-User Info field for each STA. For example, if we use one Per-User Info field to indicate 32 STAs, then the length of Per-User info field is reduced from 160 bytes to 5 bytes. Assuming that the length of Per-user Info field is 5 bytes, the length of MU-RTS is then only 63 us with a 6 Mbps MCS. Furthermore, as discussed below, the common information field and per-user information field may be compressed or be redesigned to repurpose some of the fields to reduce the length of the MU-RTS frame further and/or indicate parameters specific to the MU-RTS.

The methods and devices described herein work well with the currently specified MU-RTS format and greatly reduce the length of the MU-RTS frame. The described techniques also enable operation of 20 MHz only devices such as Internet-of-Things (IOT) devices where low cost is a consideration. Different 20 MHz devices can be assigned to different groups in different 20 MHz channels. Each per-user information field will then trigger CTS responses only in specific groups that then respond only on the allocated 20 MHz channels. An example is shown in FIG. 7, where Group 1 consists of 20 MHz only devices and group 2 consists of 80 MHz capable devices. Another example is shown in FIG. 8 where there are four groups of 20 MHz devices camped in different 20 MHz channels.

In one embodiment, users (i.e., stations) are grouped together dynamically or statically by the AP, and a specific group and/or group transmission profile is indicated, for example but not limited to, using the following methodology. Each Per-User Info field in an MU-RTS frame is used to trigger CTS responses from multiple STAs. The set of STAs triggered by each Per-User Info field is referred to as a group. To identify a group of STAs, the following methods may be used. The first bit of of the user identifier field is used to indicate if the per-user information field is for one STA or a group of STAs. To indicate the association ID (AID) of the STAs, only 11 bits are needed, so one bit in the User identifier field can be used (e.g., the first bit). This design may allow some per-user information in a Trigger frame to indicate a group of STAB (e.g., if the first bit of the per-user info is set) and some per-user information in a Trigger frame to indicate only one STA (e.g., if the first bit of the per-user info is not set).

In further embodiments, the Coding Type, MCS, DCM (dual carrier modulation), and SS (spatial stream) allocation fields may be repurposed for additional signaling in the Per User Info field. These fields can be used for other purposes because the response type of a CTS frame is determined and the rate of CTS frame transmission is determined by control rate response rule. For example, the SS allocation may be set as 5 or 6 bits. The RU (resource unit) allocation is used to indicate the bandwidth of the CTS response from the group, and the target RSSI (received signal strength indication) is used to provide control of the allocated STAs in the group. Some repurposed bits can be used to indicate a CCA (clear channel assessment) threshold to be used for CCA checking when responding to the MU-RTS, and some repurposed bits can be used to indicate a formula for transmission power control. In a particular embodiment, one bit in a repurposed field may be used to indicate that a CTS response is not required. This can be used to exclude some stations from the group for CTS response so that some STAs in a group do not need to update frequently. For example, if a STA is per-user info field with group mode indicated for CTS response and in a per-user info field with individual mode indicated for no CTS response, then the STA will not respond to the CTS. This can be used to indicate that a STA or a group of STAs will participate in the following MU DL or UL operation, but CTS responses are not required. In one embodiment, one bit in a repurposed field is used to indicate the method of identifying the group when the bit in the User identifier field indicates a group. This bit could be, for example, a bit of the coding type field. This bit is only needed when there are two approaches for group identification as discussed below.

When the bit in the user identifier field is set to indicate that the per-user information field is for a group of STAs, the following methods may be used for group allocation. In one embodiment, a Group ID is allocated to identify a set of STAs in the group. The Group ID can be defined in addition to the STA ID, and 2048 groups may be defined with 11 bits. The Group ID can be located in the User Identifier field or part of the User Identifier as shown in FIG. 9 (e.g., the last 11 bits).

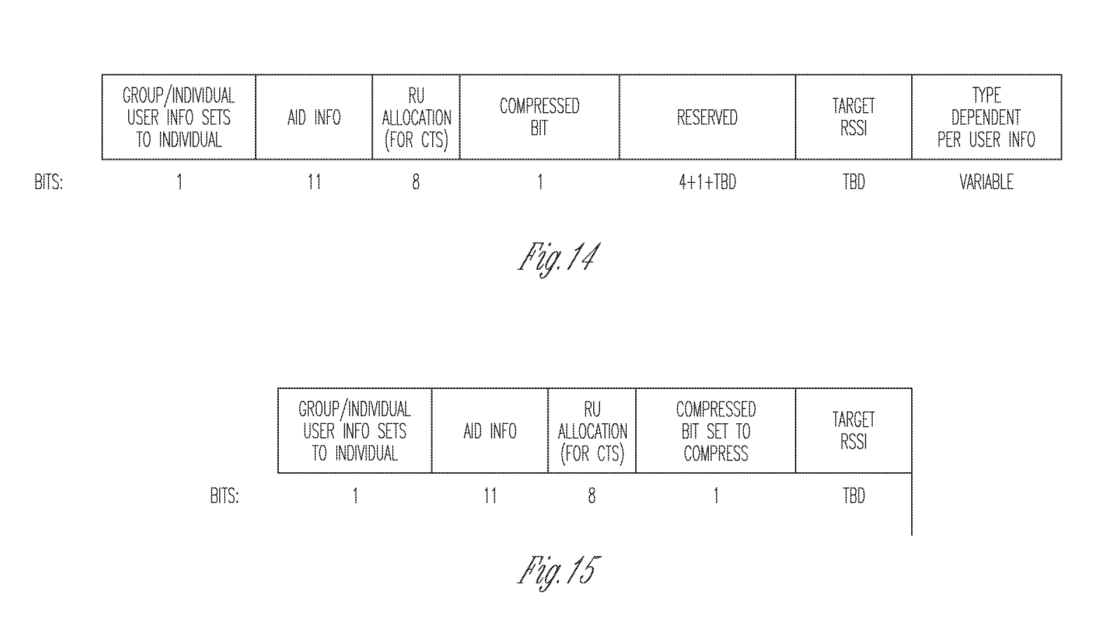

In another embodiment, group allocation may be performed by defining a Start AID and a range to identify the group of devices. For example, the last 11 bits in the user identifier field may be used to indicate the start AID, and the rest of the repurposed bits may be used to indicate the range. For example, if the start AID is 1 and the range is 1000, then from 1 to 1001 or 1000 are the STAs identified in the group. As a variation of this technique, a bitmap with fixed length may be used to indicate the stations. For example, if the xth bit is 1, this would indicate the station with AID equal to start AID+(x-1) is in the group. Examples of the frame format of the per-user information field in certain embodiments are shown in FIGS. 10 through 15. FIG. 10 shows the general format of per-user information field when Group/Individual user info is set to group. FIG. 11, shows an example when the range of AIDs a group is present. FIG. 12 shows an example when the range of AIDs is not present. In FIG. 13, an example of a general format of the per-user information field when Group/Individual user info is set to individual.

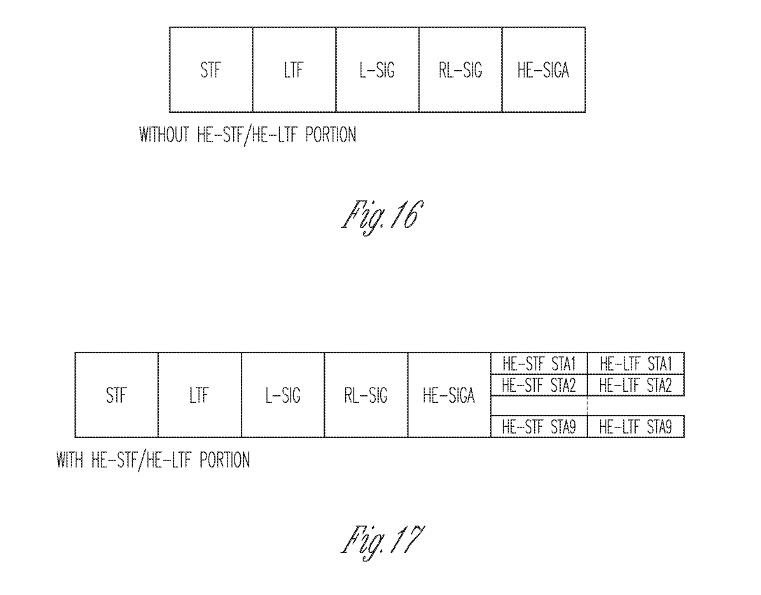

If one of the above-described methods for indicating the group is employed, then one bit may be used to indicate if a certain field in the per-user information field is compressed as shown in FIG. 14. In one embodiment, different per-user information fields are defined based on the PHY (physical layer) format of the MU-RTS. For example, the per-user information field may be compressed when the PHY format of CTS is not HE (high efficiency) or the PHY format of RTS is non-HE. An example where the field is compressed is shown in FIG. 15.

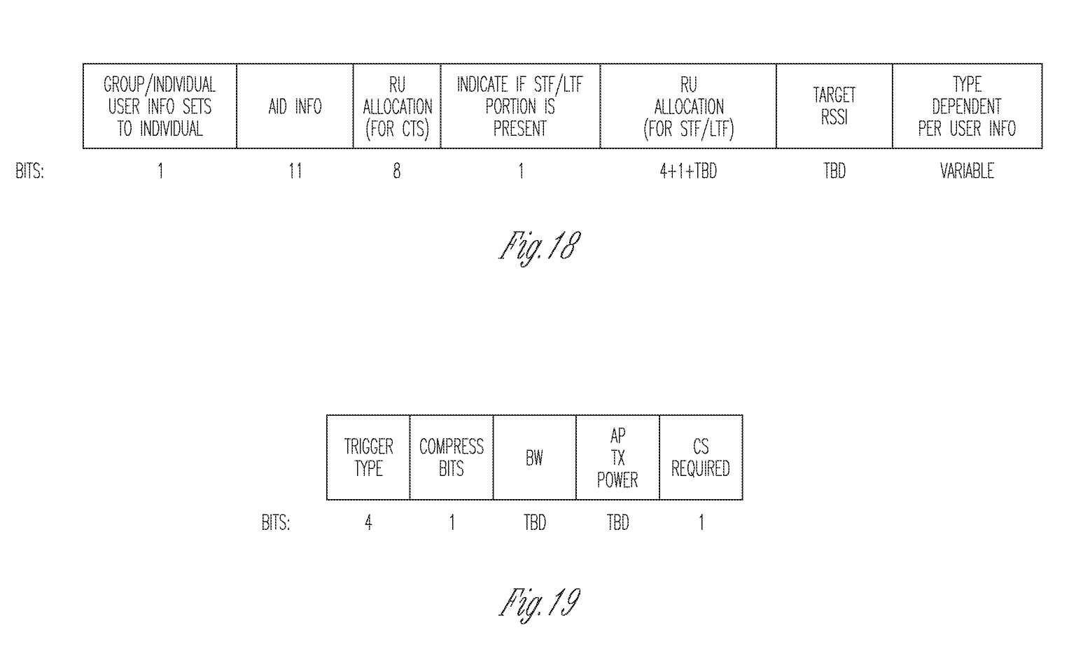

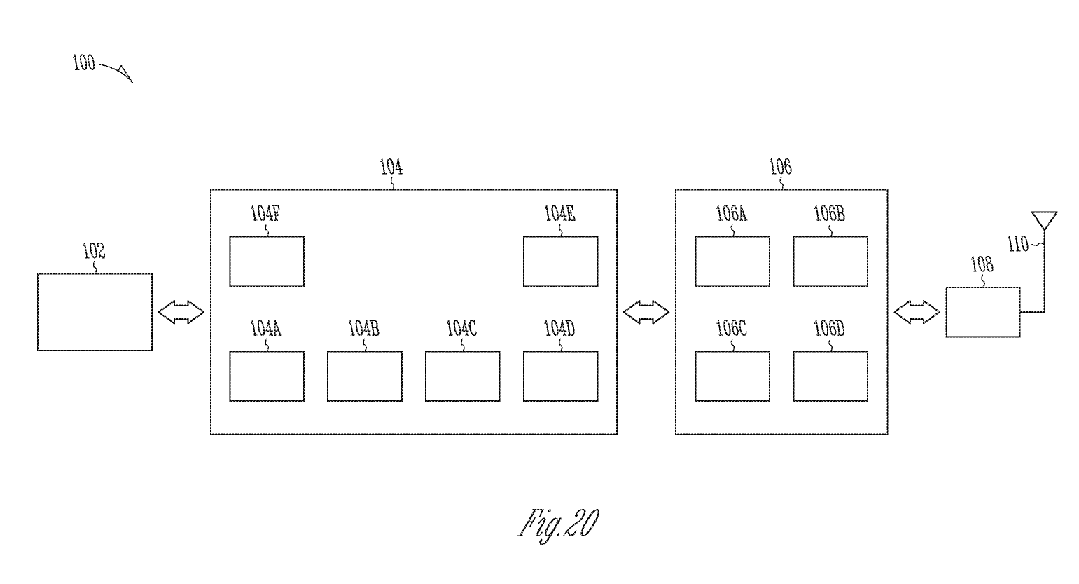

When the MU-RTS is carried in HE SU format, the MU-CTS is carried in HE SU format as well. Further, since the important information is in HE-SIG-A already, we can have NDP format of MU-CTS with or without a long training field (HE-LTF) and short training field (HE-STF) portion as shown in FIGS. 16 and 17. In one embodiment, when the per-user information field is set to Individual, one bit is used to indicate if HE-STF/HE-LTF portion is present. This can be combined with the compressed bit before, i.e., if the field is not compressed, then RU allocation for HE-STF/HE-LTF is present. As an alternative, the length field in the common information field may be used to indicate if HE-STF/HE-LTF is present. If the length field includes the duration of HE-STF/HE-LTF, then HE-STF/HE-LTF is present. If the length field does not include the duration of HE-STF/HE-LTF, then HE-STF/HE-LTF is not present. If HE-STF/HE-LTF portion is present, then additional RU allocation for HE-STF/HE-LTF is present. Note that the signaling is only required if MU-CTS is carried in HE format. This approach can also be combined with indicating the group ID as proposed above in HE format. The HE-STF/HE-LTF can then be used by the AP to understand if there is at least one STA in the group responding with a CTS. Some HE-STF/HE-LTF code (e.g., the P-matrix) can be pre-defined in the frame that defines the group ID for each STA in the group. The code can also be assigned implicitly based on the order of STA in the group. For example, the first STA in the group uses the first code and so on and so forth. With the pre-defined code, the AP can then know which STA in the group responds with a CTS. The HE-STF portion and HE-LTF portion of different STAs could be the same if there is no additional HE-STF/HE-LTF allocation in the group assignment. An example of this additional signaling is shown in FIG. 18.

Embodiments for compressing the common information field of the CTS frame will now be described. Note that when a CTS response is non-HT, the length, cascade indication, CP and LTF type, MU MIMO LTF, # of LTFs, STBC, LDPC extra symbol, and Packet Extension fields are not needed. Hence, three bytes are saved if the common information is compressed by eliminating those fields. In one embodiment, the common information field is reordered so that the field that is not needed by the MU-RTS in non-HT format is put at the end. The Trigger type field may be present as the first field in the common info field. The type-dependent common information may be the second field in the common information field. One compress bit may be assigned assigned as the type-dependent common information field. If the bit is set, then the field not needed by the MU-RTS is compressed. An example of a compressed common information field is shown in FIG. 19.

Other approaches to compress the common information field include defining another type of trigger referred to as a compressed MU-RTS where a compressed MU-RTS either has or may have a compressed common information field. A compressed MU-RTS may be sent when it is transmitted in non-HT format, which may require a compressed format. In another embodiment, if the bits are not compressed to have a consistent format for a trigger frame, then the unused fields may be reserved.

### Example UE Description

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

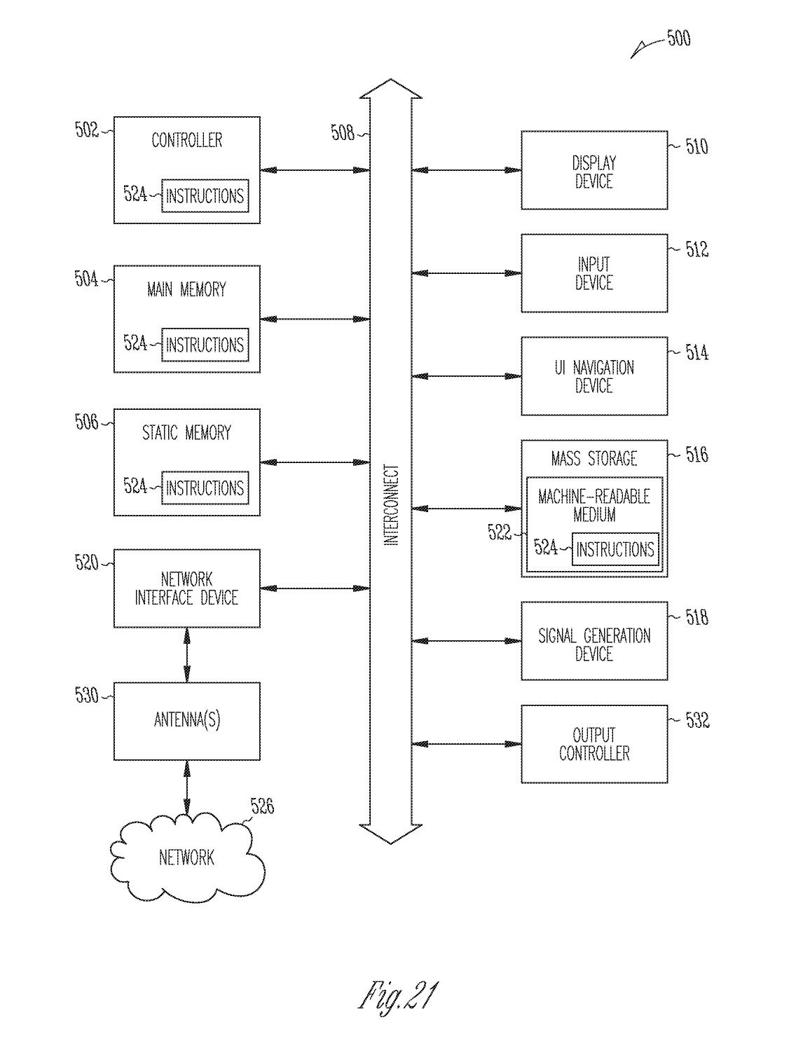

Embodiments described herein may be implemented into a system using any suitably configured hardware and/or software. FIG. 20 illustrates, for one embodiment, example components of a User Equipment (UE) device 100. In some embodiments, the UE device 100 may include application circuitry 102, baseband circuitry 104, Radio Frequency (RF) circuitry 106, front-end module (FEM) circuitry 108 and one or more antennas 110, coupled together at least as shown.

The application circuitry 102 may include one or more application processors. For example, the application circuitry 102 may include circuitry such as, but not limited to, one or more single-core or multi-core processors. The processor(s) may include any combination of general-purpose processors and dedicated processors (e.g., graphics processors, application processors, etc). The processors may be coupled with and/or may include memory/storage and may be configured to execute instructions stored in the memory/storage to enable various applications and/or operating systems to run on the system.

The baseband circuitry 104 may include circuitry such as, but not limited to, one or more single-core or multi-core processors. The baseband circuitry 104 may include one or more baseband processors and/or control logic to process baseband signals received from a receive signal path of the RF circuitry 106 and to generate baseband signals for a transmit signal path of the RF circuitry 106. Baseband processing circuitry 104 may interface with the application circuitry 102 for generation and processing of the baseband signals and for controlling operations of the RF circuitry 106. For example, in some embodiments, the baseband circuitry 104 may include a second generation (2G) baseband processor 104a, third generation (3G) baseband processor 104b, fourth generation (4G) baseband processor 104c, and/or other baseband processor(s) 104d for other existing generations, generations in development or to be developed in the future (e.g., fifth generation (5G), 6G, etc.). The baseband circuitry 104 (e.g., one or more of baseband processors 104a-d) may handle various radio control functions that enable communication with one or more radio networks via the RF circuitry 106. The radio control functions may include, but are not limited to, signal modulation/demodulation, encoding/decoding, radio frequency shifting, etc. In some embodiments, modulation/demodulation circuitry of the baseband circuitry 104 may include Fast-Fourier Transform (HT), preceding, and/or constellation mapping/demapping functionality. In some embodiments, encoding/decoding circuitry of the baseband circuitry 104 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 104 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 104e of the baseband circuitry 104 may be configured to run elements of the protocol stack for signaling of the PHY, MAC, RLC, PDCP and/or RRC layers. In some embodiments, the baseband circuitry may include one or more audio digital signal processor(s) (DSP) 104f. The audio DSP(s) 104f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 104 and the application circuitry 102 may be implemented together such as, for example, on a system on a chip (SOC).

In some embodiments, the baseband circuitry 104 may provide for communication compatible with one or more radio technologies. For example, in some embodiments, the baseband circuitry 104 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 104 is configured to support radio communications of more than one wireless protocol may be referred to as multi-mode baseband circuitry.

RF circuitry 106 may enable communication with wireless networks using modulated electromagnetic radiation through a non-solid medium. In various embodiments, the RF circuitry 106 may include switches, filters, amplifiers, etc. to facilitate the communication with the wireless network. RF circuitry 106 may include a receive signal path which may include circuitry to down-convert RF signals received from the FEM circuitry 108 and provide baseband signals to the baseband circuitry 104. RF circuitry 106 may also include a transmit signal path which may include circuitry to up-convert baseband signals provided by the baseband circuitry 104 and provide RF output signals to the FEM circuitry 108 for transmission.

In some embodiments, the RF circuitry 106 may include a receive signal path and a transmit signal path. The receive signal path of the RF circuitry 106 may include mixer circuitry 106a, amplifier circuitry 106b and filter circuitry 106c. The transmit signal path of the RF circuitry 106 may include filter circuitry 106c and mixer circuitry 106a. RF circuitry 106 may also include synthesizer circuitry 106d for synthesizing a frequency for use by the mixer circuitry 106a of the receive signal path and the transmit signal path. In some embodiments, the mixer circuitry 106a of the receive signal path may be configured to down-convert RF signals received from the FEM circuitry 108 based on the synthesized frequency provided by synthesizer circuitry 106d. The amplifier circuitry 106b may be configured to amplify the down-converted signals and the filter circuitry 106c may be a low-pass filter (LPF) or band-pass filter (BPF) configured to remove unwanted signals from the down-converted signals to generate output baseband signals. Output baseband signals may be provided to the baseband circuitry 104 for further processing. In some embodiments, the output baseband signals may be zero-frequency baseband signals, although this is not a requirement. In some embodiments, mixer circuitry 106a of the receive signal path may comprise passive mixers, although the scope of the embodiments is not limited in this respect.

In some embodiments, the mixer circuitry 106a of the transmit signal path may be configured to up-convert input baseband signals based on the synthesized frequency provided by the synthesizer circuitry 106d to generate RF output signals for the FEM circuitry 108. The baseband signals may be provided by the baseband circuitry 104 and may be filtered by filter circuitry 106c. The filter circuitry 106c may include a low-pass filter (LPF), although the scope of the embodiments is not limited in this respect.

In some embodiments, the mixer circuitry 106a of the receive signal path and the mixer circuitry 106a of the transmit signal path may include two or more mixers and may be arranged for quadrature downconversion and/or upconversion respectively. In some embodiments, the mixer circuitry 106a of the receive signal path and the mixer circuitry 106a of the transmit signal path may include two or more mixers and may be arranged for image rejection (e.g., Hartley image rejection). In some embodiments, the mixer circuitry 106a of the receive signal path and the mixer circuitry 106a may be arranged for direct downconversion and/or direct upconversion, respectively. In some embodiments, the mixer circuitry 106a of the receive signal path and the mixer circuitry 106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 106 may include analog-to-digital converter (ADC) and digital-to-analog converter (DAC) circuitry and the baseband circuitry 104 may include a digital baseband interface to communicate with the RF circuitry 106.

In some dual-mode embodiments, a separate radio IC circuitry may be provided for processing signals for each spectrum, although the scope of the embodiments is not limited in this respect.

In some embodiments, the synthesizer circuitry 106d may be a fractional-N synthesizer or a fractional N/N+1 synthesizer, although the scope of the embodiments is not limited in this respect as other types of frequency synthesizers may be suitable. For example, synthesizer circuitry 106d may be a delta-sigma synthesizer, a frequency multiplier, or a synthesizer comprising a phase-locked loop with a frequency divider.

The synthesizer circuitry 106d may be configured to synthesize an output frequency for use by the mixer circuitry 106a of the RF circuitry 106 based on a frequency input and a divider control input. In some embodiments, the synthesizer circuitry 106d may be a fractional N/N+1 synthesizer.

In some embodiments, frequency input may be provided by a voltage controlled oscillator (VCO), although that is not a requirement. Divider control input may be provided by either the baseband circuitry 104 or the applications processor 102 depending on the desired output frequency. In some embodiments, a divider control input (e.g., N) may be determined from a look-up table based on a channel indicated by the applications processor 102.

Synthesizer circuitry 106d of the RF circuitry 106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 106 may include an IQ/polar converter.

FEM circuitry 108 may include a receive signal path which may include circuitry configured to operate on RF signals received from one or more antennas 110, amplify the received signals and provide the amplified versions of the received signals to the RF circuitry 106 for further processing. FEM circuitry 108 may also include a transmit signal path which may include circuitry configured to amplify signals for transmission provided by the RF circuitry 106 for transmission by one or more of the one or more antennas 110.

In some embodiments, the FEM circuitry 108 may include a TX/RX switch to switch between transmit mode and receive mode operation. The FEM circuitry may include a receive signal path and a transmit signal path. The receive signal path of the FEM. circuitry may include a low-noise amplifier (LNA) to amplify received RF signals and provide the amplified received RF signals as an output (e.g., to the RF circuitry 106). The transmit signal path of the FEM circuitry 108 may include a power amplifier (PA) to amplify input RF signals (e.g., provided by RF circuitry 106), and one or more filters to generate RF signals for subsequent transmission (e.g., by one or more of the one or more antennas 110.

In some embodiments, the UE device 100 may include additional elements such as, for example, memory storage, display, camera, sensor, and/or input/output (I/O) interface.

### Example Machine Description

FIG. 21 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a user equipment (UE), evolved Node B (eNB), Wi-Fi access point (AP), Wi-Fi station (STA), personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®, IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes and Examples

In Example 1, an apparatus for a wireless station device, comprises: memory and processing circuitry to configure the device to communicate in a wireless network; wherein the processing circuitry is to: encode a multi-user request-to-send (MU-RTS) frame that indicates a group of stations are to respond with clear-to-send (CTS) frames; and, encode an indication of the stations belonging to the group that are to respond with CTS frames in a per user information field of the MU-RTS frame.

In Example 2, the subject matter of any of the Examples herein may optionally include wherein the processing circuitry is further to use a bit in a user identifier field of the per user information field of the MU-RTS frame to indicate whether the per user information field is for a group of stations or for a single station.

In Example 3, the subject matter of any of the Examples herein may optionally include wherein the processing circuitry is further to indicate the group of stations that are to respond with CTS frames (or other types of frames such as a null data packet (NDP)) by a group identification (ID) that is contained within the user identifier field of the per user information field of the MU-RTS frame.

In Example 4, the subject matter of any of the Examples herein may optionally include wherein the processing circuitry is to indicate the group of stations that are to respond with CTS frames by a starting association identification (AID) that is contained within the user identifier field of the per user information field of the MU-RTS frame and a range of AIDs contained in another field of the per user information field.

In Example 5, the subject matter of any of the Examples herein may optionally include wherein the processing circuitry is to indicate the group of stations that are to respond with CTS frames by a starting association identification (AID) that is contained within the user identifier field of the per user information field of the MU-RTS frame and a fixed length bitmap contained in another field of the per user information field.

In Example 6, the subject matter of any of the Examples herein may optionally include wherein the processing circuitry is to encode one or more of a clear channel assessment (CCA) threshold, a formula for transmission power control, and/or an indication that a station is not to respond with a CTS frame into the per user information field of the MU-RTS frame.

In Example 7, the subject matter of any of the Examples herein may optionally include wherein the processing circuitry is to encode a resource unit allocation field in the per user information field to indicate a bandwidth for the CTS frames to be transmitted by the stations belonging to the group.

In Example 8, the subject matter of any of the Examples herein may optionally include wherein the processing circuitry is to assign different stations to different groups in accordance with the bandwidth capabilities of the different stations,

In Example 9, the subject matter of any of the Examples herein may optionally include wherein the processing circuitry is to encode a target received signal strength indication (RSSI) in the per user information field for use by the stations belonging to the group.

In Example 10, the subject matter of any of the Examples herein may optionally include wherein the processing circuitry is to encode a compression bit in the per user information field of the MU-RTS frame to indicate whether or not the per user information field is compressed.

In Example 11, the subject matter of any of the Examples herein may optionally include wherein the processing circuitry is to encode a compression bit in the common information field of the MU-RTS frame to indicate whether or not the common information field is compressed.

In Example 12, the subject matter of any of the Examples herein may optionally include wherein the processing circuitry is to indicate that a station is to respond to an MU-RTS frame with a CTS frame having a high-efficiency short training frame/long training frame (HE-STF/HE-LTF) portion by via a bit in the per user information field of the MU-RTS frame.

In Example 13, the subject matter of any of the Examples herein may optionally include wherein the processing circuitry is to indicate that a station is to respond to an MU-RTS frame with a CTS frame having a high-efficiency short training frame/long training frame (HE-STF/HE-LTF) portion via a length field in the common information field of the MU-RTS frame that indicates a duration of the HE-STF/HE-LTF portion.

In Example 14, the subject matter of any of the Examples herein may optionally include wherein the processing circuitry is to encode a compression bit in the common information field of the MU-RTS frame to indicate whether or not the common information field is compressed.

In Example 15, the subject matter of any of the Examples herein may optionally include a radio transceiver having one or more antennas connected to the processing circuitry.

In Example 16, a computer-readable medium contains instructions to cause a wireless station device (STA), upon execution of the instructions by processing circuitry of the STA, to perform any of the functions of the processing circuitry as recited by any of the Examples herein.

In Example 17, a method for operating a wireless station comprises performing any of the functions of the processing circuitry and/or radio transceiver as recited by any of the Examples herein

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the disclosure is not limited in this respect. An example LTE system includes a number of mobile stations, defined by the LTE specification as User Equipment (UE), communicating with a base station, defined by the LTE specifications as an eNodeB.

Antennas referred to herein may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

In some embodiments, a receiver as described herein may be configured to receive signals in accordance with specific communication standards, such as the institute of Electrical and Electronics Engineers (IEEE) standards including IEEE 802.11-2007 and/or 802.11(n) standards and/or proposed specifications for WLANs, although the scope of the disclosure is not limited in this respect as they may also be suitable to transmit and/or receive communications in accordance with other techniques and standards. In some embodiments, the receiver may be configured to receive signals in accordance with the IEEE 802.16-2004, the IEEE 802.16(e) and/or IEEE 802.16(m) standards for wireless metropolitan area networks (WMANs) including variations and evolutions thereof, although the scope of the disclosure is not limited in this respect as they may also be suitable to transmit and/or receive communications in accordance with other techniques and standards. In some embodiments, the receiver may be configured to receive signals in accordance with the Universal Terrestrial Radio Access Network (UTRAN) LTE communication standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” May 2005 and related amendments/versions. For more information with respect to UTRAN-LTE standards, see the 3rd Generation Partnership Project (3GPP) standards for UTRAN-LTE, release 8, March 2008, including variations and evolutions thereof.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An apparatus for a wireless station device, the apparatus comprising:
memory and processing circuitry to configure the device to communicate in a wireless network;
wherein the processing circuitry is to:
encode a multi-user request-to-send (MU-RTS) frame that indicates a group of stations are to respond with clear-to-send (CTS) frames; and,
encode an indication of the stations belonging to the group that are to respond with CTS frames in a per user information field of the MU-RTS frame,

2. The apparatus of claim 1 wherein the processing circuitry is further to use a bit in a user identifier field of the per user information field of the MU-RTS frame to indicate whether the per user information field is for a group of stations or for a single station.

3. The apparatus of claim 1 wherein the processing circuitry is further to indicate the group of stations that are to respond with CTS frames by a group identification (ID) that is contained within the user identifier field of the per user information field of the MU-RTS frame.

4. The apparatus of claim 1 wherein the processing circuitry is to indicate the group of stations that are to respond with CTS frames by a starting association identification (AID) that is contained within the user identifier field of the per user information field of the MU-RTS frame and a range of AIDs contained in another field of the per user information field.

5. The apparatus of claim 1 wherein the processing circuitry is to indicate the group of stations that are to respond with CTS frames by a starting association identification (AID) that is contained within the user identifier field of the per user information field of the MU-RTS frame and a fixed length bitmap contained in another field of the per user information field.

6. The apparatus of claim 1 wherein the processing circuitry is to encode one or more of a clear channel assessment (CCA) threshold, a formula for transmission power control, and/or an indication that a station is not to respond with a CTS frame into the per user information field of the MU-RTS frame.

7. The apparatus of claim 1 wherein the processing circuitry is to encode a resource unit allocation field in the per user information field to indicate a bandwidth for the CTS frames to be transmitted by the stations belonging to the group.

8. The apparatus of claim 7 wherein the processing circuitry is to assign different stations to different groups in accordance with the bandwidth capabilities of the different stations.

9. The apparatus of claim 1 wherein the processing circuitry is to encode a target received signal strength indication (RSSI) in the per user information field for use by the stations belonging to the group.

10. The apparatus of claim 1 wherein the processing circuitry is to encode a compression bit in the per user information field of the MU-RTS frame to indicate whether or not the per user information field is compressed.

11. The apparatus of claim 1 wherein the processing circuitry is to encode a compression bit in the common information field of the MU-RTS frame to indicate whether or not the common information field is compressed.

12. The apparatus of claim 1 wherein the processing circuitry is to indicate that a station is to respond to an MU-RTS frame with a CTS frame having a high-efficiency short training frame/long training frame (HE-STF/HE-LTF) portion by via a bit in the per user information field of the MU-RTS frame.

13. The apparatus of claim 1 wherein the processing circuitry is to indicate that a station is to respond to an MU-RTS frame with a CTS frame having high-efficiency a short training frame/long training frame (HE-STF/HE-LTF) portion via a length field in the common information field of the MU-RTS frame that indicates a duration of the HE-STF/HE-LTF portion.

14. The apparatus of claim 1 wherein the processing circuitry is to encode a compression bit in the common information field of the MU-RTS frame to indicate whether or not the common information field is compressed.

15. The apparatus of claim 1 further comprising a radio transceiver having one or more antennas connected to the processing circuitry.

16. A method for operating a wireless station, comprising:
encoding a multi-user request-to-send (MU-RTS) frame that indicates a group of stations are to respond with clear-to-send (CTS) frames; and,
encoding an indication of the stations belonging to the group that are to respond with CTS frames in a per user information field of the MU-RTS frame.

17. The method of claim 16 further comprising using a bit in a user identifier field of the per user information field of the MU-RTS frame to indicate whether the per user information field is for a group of stations or for a single station.

18. The method of claim 16 further comprising indicating the group of stations that are to respond with CTS frames by a group identification (ID) that is contained within the user identifier field of the per user information field of the MU-RTS frame.

19. The method of claim 16 further comprising indicating the group of stations that are to respond with CTS frames by a starting association identification (AID) that is contained within the user identifier field of the per user information field of the MU-RTS frame and a range of AIDs contained in another field of the per user information field.

20. The method of claim 16 further comprising indicating the group of stations that are to respond with CTS frames by a starting association identification (AID) that is contained within the user identifier field of the per user information field of the MU-RTS frame and a fixed length bitmap contained in another field of the per user information field.

21. A computer-readable medium comprising instructions to cause a wireless station device (STA), upon execution of the instructions by processing circuitry of the STA, to:
encode a multi-user request-to-send (MU-RTS) frame that indicates a group of stations are to respond with clear-to-send (CTS) frames; and,
encode an indication of the stations belonging to the group that are to respond with CTS frames in a per user information field of the MU-RTS frame.

22. The medium of claim 21 further comprising instructions to use a bit in a user identifier field of the per user information field of the MU-RTS frame to indicate whether the per user information field is for a group of stations or for a single station.

23. The medium of claim 21 further comprising instructions to indicate the group of stations that are to respond with CTS frames by a group identification (ID) that is contained within the user identifier field of the per user information field of the MU-RTS frame.

24. The medium of claim 21 further comprising instructions to indicate the group of stations that are to respond with CTS frames by a starting association identification (AID) that is contained within the user identifier field of the per user information field of the MU-RTS frame and a range of AIDs contained in another field of the per user information field.

25. The medium of claim 21 further comprising instructions to indicate the group of stations that are to respond with CTS frames by a starting association identification (AID) that is contained within the user identifier field of the per user information field of the MU-RTS frame and a fixed length bitmap contained in another field of the per user information field.
